(19) United States
(12) Patent Application Publication
(10) Pub. No.: US 2004/0076001 A1
(43) Pub. Date: Apr. 22, 2004

(54) Leadless ballast

(76) Inventor: Arthur L. Lutes, Stuart, FL (US)

Correspondence Address: MCHALE & SLAVIN, 4440 PGA BLVD, SUITE 402, PALM BEACH GARDENS, FL, 33410, US

(21) Appl. No.: 10/273,047

(22) Filed: Oct. 17, 2002

(51) Int. Cl. F21S 4/00

(52) U.S. Cl. 362/221; 362/217; 362/260

(57) ABSTRACT

A leadless ballast and a mounting assembly therefor comprises a ballast housing having a length and a width, and including a top face, a bottom face, left and right side faces, and first and second end faces. The first end face has a plurality of male electrical connectors extending outwardly therefrom with the electrical connectors being electrically coupled to a conventional-ballast component within the ballast housing. The ballast housing is receive in a mounting bracket configured for complementary engagement with the ballast housing. The mounting bracket has a width and length approximately equal to the length and width of the ballast housing. The mounting bracket includes left and right side walls and a front wall which are contiguous and normal to the base. The front wall includes a plurality of female sockets adapted for mated engagement with the male connectors which terminate in jacks extending through the front walls. The jacks are adapted to receive a plurality of electrical leads from the fluorescent fixture. In an alternative embodiment designed for snap-in installation, the left and right side walls have downwardly-angled flanges which engage with the left and right lips of the ballast. A retrofit adapter kit is also disclosed.

### FIELD OF THE INVENTION

This invention relates generally to the field of ballasts used for fluorescent lamp fixtures and, more particularly, to a leadless ballast housing and mounting bracket assembly for use with OEM or after market fluorescent lamp fixtures.

### BACKGROUND OF THE INVENTION

A conventional fluorescent lighting fixture includes a ballast to provide the relatively high input voltage necessary to create a voltage potential across a fluorescent lamp to energize the gas resulting in light. The ballast is secured to a lighting fixture, and the high and low sides of the ballast are wired directly into the circuit of the lighting fixture.

Fluorescent light ballasts are quite old in the art and have become standardized in their shape and enclosure size, wherein the ballast housing constructed from two sheet-metal pieces. One of the sheet-metal pieces is die-cut and bent to provide two generally vertical side faces, a base wall, and transitional angled faces between the base and the vertical side faces. The first pieces is fitted within a second piece which forms a cover for the housing.

The prevailing standard in the fluorescent lighting industry has been to provide electrical leads which extend through each end wall of the ballast housing, respectively. Some of the leads connect with a lamp socket, and others are coupled with the input power leads.

Fluorescent light ballasts must be periodically replaced because they have become burned out or are otherwise defective. For industry-standard ballasts, this process can be quite labor intensive. The old ballast must first be detached from the lamp fixture (usually mounted on a ceiling) by removal of the screws in the mounting plate. This action requires that the relatively heavy ballast be held in place on the ceiling over the head of the installer until all screws are removed. Installation of the new ballast requires that the insulation be stripped from the ends of the fixture leads and the ballast leads. Each of the ends to be connected are twisted together, and a plastic threaded nut is then threaded over the twisted conductors. The installation of the ballast can create a hazardous situation for the installer because some of the wires extending from the can be become activated or “live” during the installation process. The presence of live wires can result in an electrical shock, or even electrocution, of the installer.

There are clear disadvantages to the above-described system of fluorescent ballast installation, however this arrangement has remained the prevailing standard for equipment in the industry, irrespective of other possibly more practical arrangements which have been disclosed in the prior art. A drawback of many of the ballast systems seen in the prior art is that they do not fit the footprint of standard ballast installations and could not be used as a retrofit for existing fixtures.

Representative examples in the prior art include U.S. Pat. Nos. 5,691,878, and 6,102,550. Van Wagener et al., U.S. Pat. No. 5,260,878, discloses a leadless ballast for an fluorescent light fixture which would fit standard installations, however a drawback of this design is that is still requires the installer to unscrew the ballast from the ceiling. Another disadvantage is that the jack containing the fluorescent light electrical leads must be manually unplugged from the ballast, which could result in a hazardous situation as live wires could become dislodged from the jack during handling.

There remains long felt need for a fluorescent ballast system which provides for safe, rapid and easy installation of a fluorescent ballast, which at the same time effectively dovetails with present standards of ballast construction, so as to overcome industry resistance to an improved ballast system.

### SUMMARY OF THE INVENTION

It is an objective of the invention to provide improved leadless ballast and mounting assembly in which the fixture wires are permanently dressed, thereby obviating the need to handle the wires in the installation process.

It is another objective to provide an improved leadless ballast and mounting assembly which does not require the use of tools for replacement of the ballast.

It is still another objective to provide an improved leadless ballast and mounting assembly which fits the footprint of standard ballasts.

It is a further objective of the invention to provide an improved leadless ballast and mounting assembly which can be utilized in existing fluorescent fixtures without modification of the fixture.

It is yet a further objective of the invention to provide an improved leadless ballast and mounting assembly which provides a degree of safety and ease of installation not seen in the prior art ballasts.

In accordance with the above objectives, a leadless ballast and a mounting assembly therefor is provided for a ballast driven fluorescent light fixture having a plurality of electrical leads coupled to at least one lamp socket and a power source comprising a ballast housing having a length and a width, and including a top face, a bottom face, left and right side faces, and first and second end faces. The first end face has a plurality of male electrical connectors extending outwardly therefrom with the electrical connectors being electrically coupled to a conventional ballast component within the ballast housing. The ballast housing is receive in a mounting bracket configured for complementary engagement with the ballast housing. The mounting bracket has a base and a means for attaching the base to a fixed structure, such as a ceiling. The attachment means can be threaded screws insertable through apertures in the base into the fixed structure. The mounting bracket has a width and length approximately equal to the length and width of the ballast housing. The mounting bracket includes left and right side walls and a front wall which are contiguous and normal to the base. The front wall includes a plurality of female sockets adapted for mated engagement with the male connectors which terminate in jacks extending through the front walls. The jacks are adapted to receive a plurality of electrical leads from the fluorescent fixture.

In another embodiment, the left and right side walls of the mounting receptacle each have at least one angled panel thereto configured for coextensive alignment with the left and right angled faces on the ballast housing, whereby the ballast housing can be inserted into the mounting bracket with the top face adjacent to the fixed structure and maintained in the mounting bracket by the angled panels.

In another embodiment, the left and right faces of the ballast housing include a plurality of tab structures protruding laterally therefrom, and the left and right side walls of the bracket include a plurality of slots configured for engagement with the plurality of tab structures.

In yet another embodiment, the mounting bracket can include left and right side walls which have a height somewhat greater than the left and right lips of the ballast housing, and the left and right side walls respectively terminate in a downwardly-angled flanges configured to engage with the left and right lips of the ballast housing to provide snap-in installation.

In another alternative embodiment, an adapter kit for a conventional fluorescent light ballast is provided which comprises a cap structure configured for mated sliding engagement to a first end of the ballast housing. The cap structure includes an end wall having a perimeter substantially identical in configuration to the perimeter ballast housing. The cap structure further includes an attachment rim extending perpendicularly from the perimeter of the end wall. The attachment rim has a top face, a bottom face, left and right side faces, and angled transition faces between the bottom face and the left and right side faces respectively with the top face being adapted for attachment to the mounting plate of the ballast housing. The end wall has an electrical connector assembly extending therethrough which includes a plurality of jacks accessible from the inside surface of the end wall wherein the jacks are adapted to be coupled to the electrical leads of the ballast and terminating in a plurality of male electrical connectors extending laterally from the outside surface of the end wall. The attachment rim includes an aperture extending therethrough adapted to receive the electrical leads from the second end of the ballast.

### BRIEF DESCRIPTION OF THE FIGURES

FIG. 1 illustrates a first embodiment of the ballast assembly of the invention in which the ballast housing is shown removed from the mounting bracket;

FIG. 2 illustrates the embodiment of FIG. 1 in which the ballast housing is installed within the mounting bracket;

FIG. 3 illustrates an alternative embodiment of the ballast assembly of the invention in which the ballast housing is shown removed from the mounting bracket;

FIG. 4 illustrates the embodiment of FIG. 3 in which the ballast housing is installed within the mounting bracket;

FIG. 5 illustrates a cross-sectional view taken along the line 5-5′ of FIG. 4;

FIG. 6 illustrated the detail of the connection shown in FIG. 5;

FIG. 7 illustrates an yet another alternative embodiment providing a retrofit adapter kit; and

FIG. 8 illustrates an alternative arrangement of the electrical connectors in the ballast housing.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

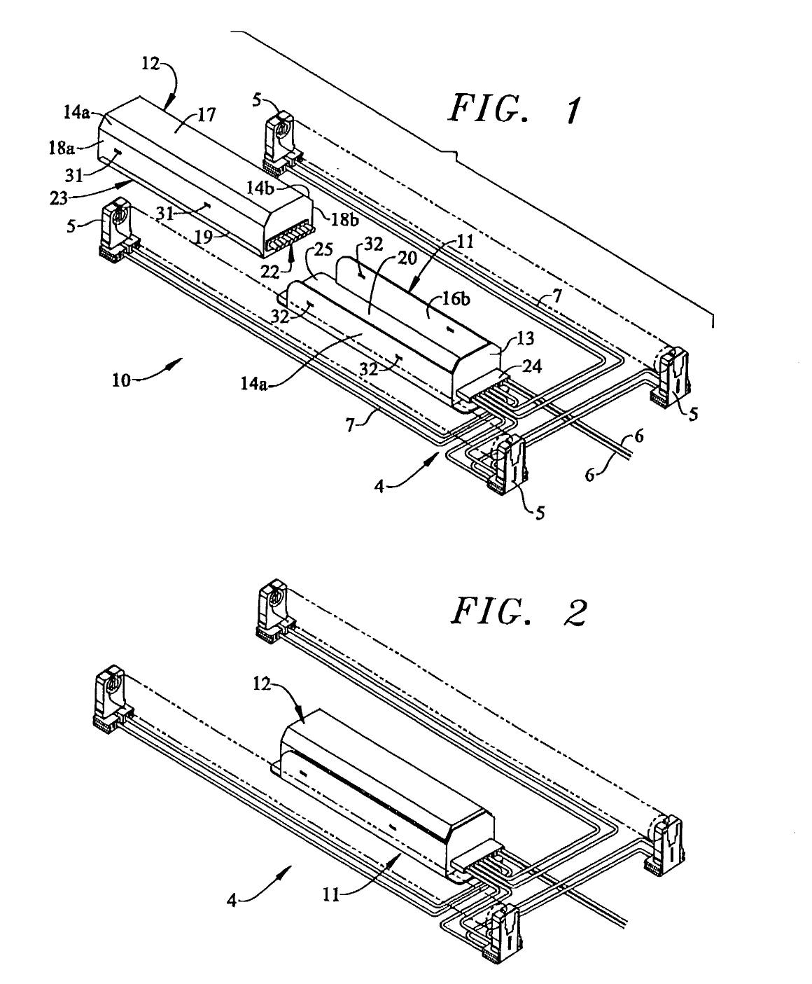

FIGS. 1-2 illustrate the components of a conventional fluorescent light fixture 4 which includes a ballast assembly in accordance with the principles of the invention, generally referred to as 10. The fluorescent light fixture 4 has at least one pair of lamp sockets 5 and a plurality of electrical leads 7 coupled the ballast to the lamp sockets 5 and leads 6 connectable to an A/C power source. The ballast assembly 10 includes the ballast housing 12 and a mounting bracket 11. FIG. 1 illustrates the ballast housing 12 as being detached from the mounting bracket 11, and FIG. 2 illustrates the ballast housing installed into the mounting bracket 11. The mounting bracket 11 is secured to a fixed structure, usually as ceiling.

The ballast housing 12 is constructed to largely have the same configuration and dimensions as a standard ballast. As is well known in the art, the ballast housing 12 is formed from two pieces of sheet metal, the first of which is die-cut and folded to provide a bottom face 17, left and right side surfaces 18a,b, and first and second end faces 21a,b. Transitional angled faces 14a and 14b are located between bottom face 17 and left and right side surfaces 18a and 18b respectively. This forms a container which is fitted with a cover structure formed from a second piece of sheet metal which provides the top face 23 and a lip 19 which extends along the length of the ballast housing 12.

In accordance with principles of the present invention, the front face 21a includes a plurality of male electrical connectors 22 extending outwardly therefrom. FIG. 1 illustrates the male electrical connectors 22 arrayed in a single row, however in another embodiment, the ballast housing can include multiple rows of electrical connectors, as shown in FIG. 8. The male electrical connectors 22 are coupled to the conventional electrical components within the ballast housing 12. To install the ballast housing 12 into the fixture, the ballast housing 12 is inserted into the mounting bracket 11, which has a configuration complementary to that of the ballast housing 12. The mounting bracket 11 preferably has a width and a length approximately equal to the length and the width of the ballast housing 12. The mounting bracket 11 can have any suitable functional configuration, and the precise configuration of the mounting bracket 11 of the invention is not limited to that shown in FIGS. 1 and 2.

The mounting bracket 11 has a base 25 to which is attached to a fixed structure using an attachment means such as threaded screws. Left and right side walls 16a,b and a front wall 13 are contiguous and normal to the base adapted for mated engagement with the male electrical connectors 22. The female sockets terminate in jacks 24 which extend through the front wall 13. The jacks 24 are adapted to receive the electrical leads 6 and 7 of the fluorescent light fixture 4.

As shown in FIG. 2, the ballast housing 12 can be inserted into the mounting bracket 11 such that the male electrical connectors 22 and engaged with the female sockets. This arrangement provides numerous advantages over prior art systems. For example, no tools are required to remove and replace the ballast, and since the electrical leads are permanently dressed within the electrical connectors 22 and the female sockets, it is not necessary for an installer to handle any wires when replacing the ballast housing 12.

Any number of methods can be used to secure the ballast housing 12 within the mounting bracket 11, however it is preferable that tools are not required. In the illustrated embodiment, the ballast housing 12 includes tab structures 31 on the left and right sides 18a,b, and the left and right sides 14a,b of the mounting bracket 11 includes corresponding slots 32 which are adapted to engage with tab structures 31. In another embodiment, metal straps can extend over the ballast housing 12 which are insertable into slots 32.

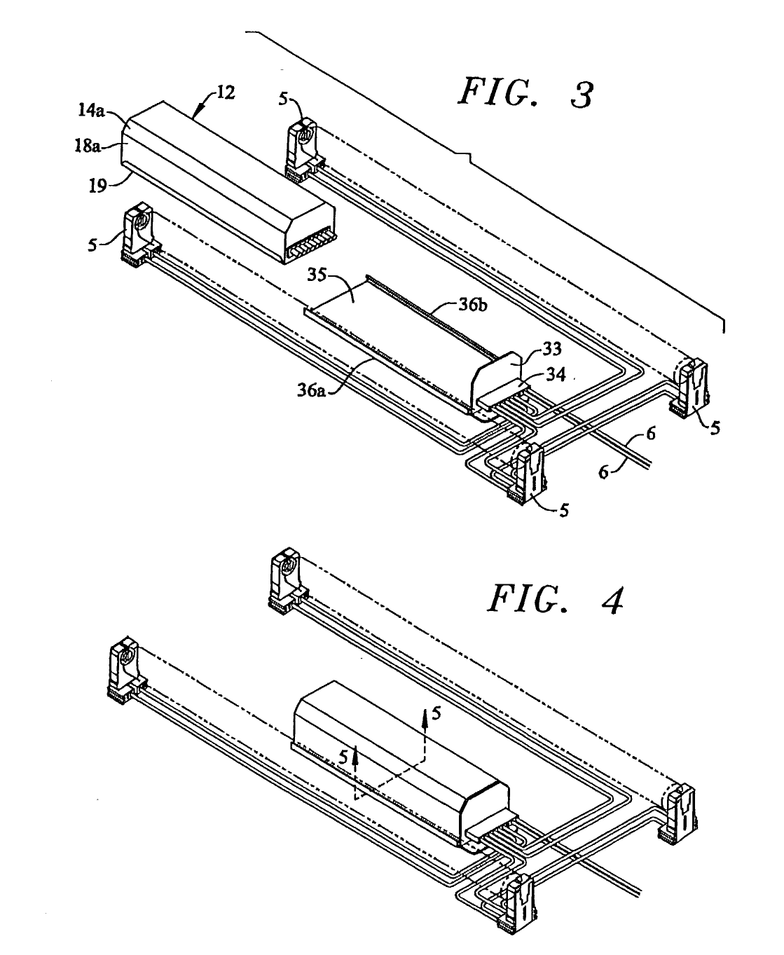

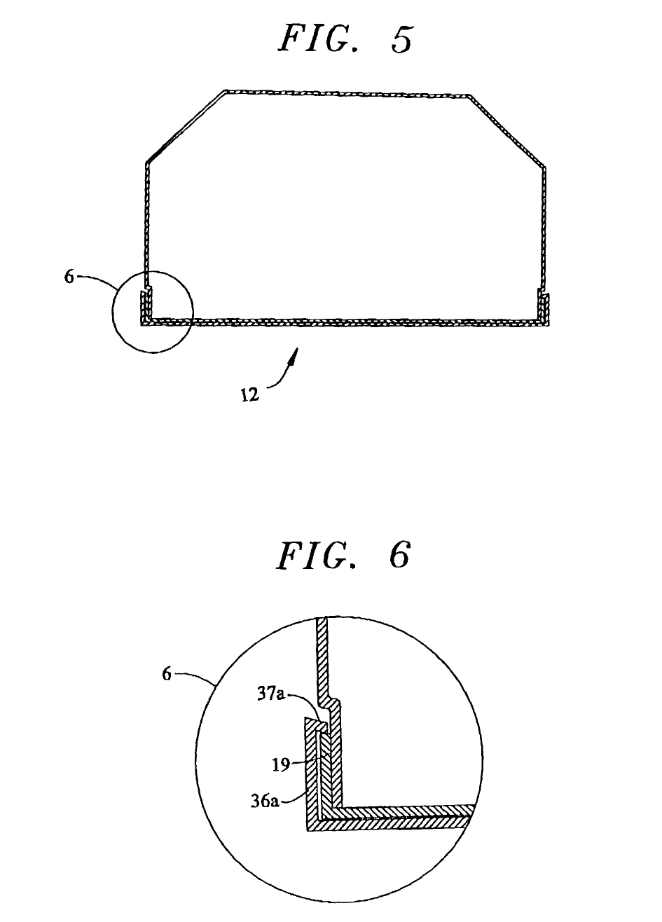

FIGS. 3 and 4 illustrate an alternative embodiment of the invention which includes the mounting bracket 41. As seen in FIG. 3, the mounting bracket 41 has a base 35 to be attached to a fixed structure, and a front wall 33 and left and right side walls 36a,b which are contiguous and normal to the base 35. FIG. 5 illustrates a cross-sectional view of the ballast housing 12 as installed in the mounting bracket 41 taken along the line 5-5′, with a detailed view of the attachment shown in FIG. 6. As can be best seen in and FIG. 6, the left side wall 36a terminates in a downwardly depending flange 37a, which engages with lip 19 to secure the ballast housing 12 within the mounting bracket 41. This arrangement advantageously allows the ballast housing 12 to be snapped into the mounting bracket 41, and then moved forward to engage the electrical connectors.

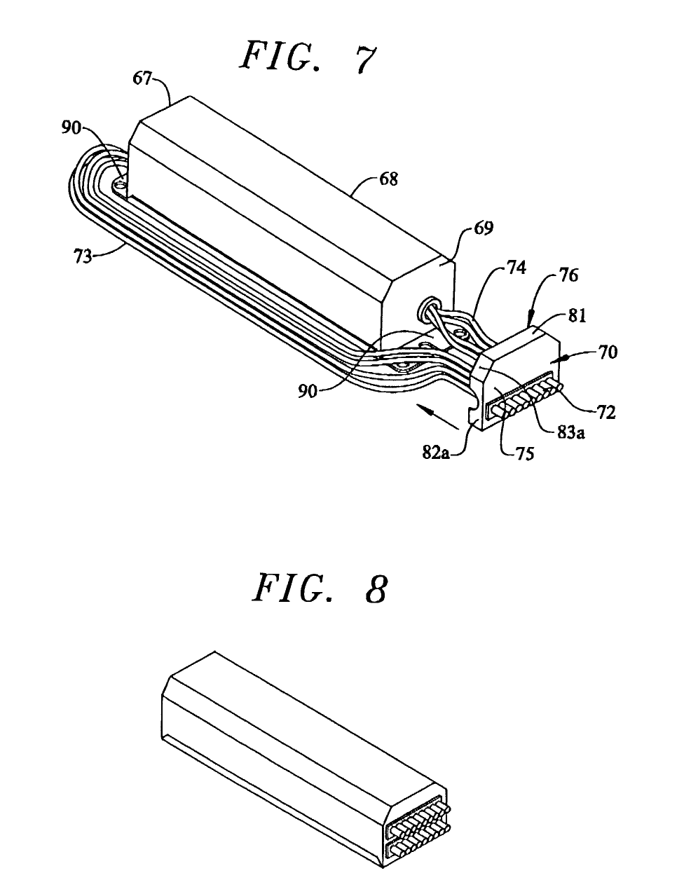

In another aspect of the invention, an existing standard ballast can be retrofit for attachment to mounting brackets 11 or 41. As seen in FIG. 7, an adapter kit can include the cap structure 70 which is configured for mated sliding engagement to a first end 69 of the ballast housing. As is the standard construction, the ballast includes a first set of electrical leads 74 extending through an aperture in the first end 69 and a second set of electrical leads similarly extending through second end 67. The cap structure has an end wall 75 which has a perimeter substantially identical in configuration to the perimeter of the first end 69. The cap structure 70 includes an attachment rim 76 extending perpendicularly from the perimeter of the end wall 70. The attachment rim has a top face (not visible in FIG. 7), a bottom face 81, left and right side faces 82a,b, and angled transition faces 83a,b between the bottom face 81 and left and right side faces 82a,b, respectively. The top face is adapted for attachment to the mounting plate 90 of the ballast housing, and can be secured using any suitable attachment means. The end wall 75 includes an electrical connector assembly extending therethrough which includes a plurality of jacks (not shown) accessible from the inside surface of the end wall which are adapted to be coupled to the electrical leads of the ballast collectively indicated as 73 and 74. The jacks terminating in a plurality of male electrical connectors 72 extending outwardly from the outside surface of said end wall. The attachment rim 76 preferably includes an aperture which allows the electrical leads 73 from the second end 67 of the ballast to be inserted through the aperture and for installation into the jack. After the cap structure 70 has been secured to the ballast 68, the now retrofitted ballast 68 can be used in conjunction with the mounting brackets 11 and 41 shown in FIGS. 1-2 and 3-4 respectively.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

I claim:

1. In a ballast driven fluorescent light fixture, a leadless ballast and a mounting assembly therefor comprising:
an improved ballast housing defined by a top face, a bottom face, left and right side faces, and first and second end faces, wherein a plurality of electrical connectors extend outward from said first end face, said electrical connectors being electrically coupled to conventional ballast circuitry mounted within said ballast housing; and
a mounting bracket for securing said ballast housing to a secure structure, said mounting bracket having left and right side walls and a front wall which are contiguous and normal to said base;
a plurality of female sockets positioned in said front wall adapted for mated engagement with said male connectors, said female sockets terminate in jacks extending through said front walls; and
means for attachment said base to a fixed structure;

2. The apparatus of claim 1, wherein said means for attachment is further defined as threaded screws insertable through said apertures located in said base.

3. The apparatus of claim 1, wherein said bottom face of said ballast housing and said left and right faces respectively include left and right angled faces therebetween, and said left and right side walls of said mounting receptacle each have at least one angled panel contiguous thereto configured for coextensive alignment with said left and right angled faces whereby said ballast housing can be inserted into said mounting bracket with said top face adjacent to said fixed structure and maintained in said mounting bracket by said angled panels.

4. The apparatus of claim 1, wherein said left and right faces of said ballast housing include a plurality of tab structures protruding laterally therefrom, and said left and right side walls of said bracket include a plurality of slots configured for engagement with said plurality of tab structures, whereby said ballast housing can be inserted into said mounting bracket with said top face adjacent to said fixed structure and said tab structures extend through said slots to thereby maintain said ballast housing in said mounting bracket.

5. In a ballast driven fluorescent light fixture, a leadless ballast and a mounting assembly therefor, comprising:
a ballast housing having a length and a width, and including top face, a bottom face, left and right side faces, and first and second end faces, said ballast housing having the conventional mode of assembly in which a base container structure is fitted within a cover structure to provide left and right lips which depend from said top face along the length of the ballast housing, said first end face include a plurality of male electrical connectors extending outwardly laterally therefrom wherein said male electrical connectors are coupled to conventional ballast components withing said ballast housing; and
a mounting bracket configured for engagement with said ballast housing wherein mounting bracket includes a base adapted for attachment to a fixed structure; said mounting bracket having a length and a width approximately equal to the length and width of said ballast housing; said mounting bracket including front wall which is contiguous and normal to said base; said front wall including a plurality of female sockets adapted for mated engagement with said male connectors, wherein said female sockets terminate in jacks extending through said front walls and said jacks are adapted to receive the plurality of electrical leads, said mounting bracket including left and right side walls contiguous and normal to said base and having a height somewhat greater than the left and right lips of the ballast housing, said left and right side walls respectively terminating in a downwardly-angled flanges configured to engage with the left and right lips of the ballast housing, whereby said ballast housing can be inserted into said mounting bracket with said top face adjacent to said fixed structure and maintained in said mounting bracket by said downwardly-angled flanges.

6. The apparatus of claim 5, wherein said base includes apertures and said attachment means comprises threaded screw insertable through said apertures into the fixed structure.

7. An adapter kit for a conventional fluorescent light ballast having a generally elongate housing defined by a top face, a bottom face, a first end face and a second end face with mounting plates extending outwardly from the first end face and the second end face respectively proximate to the top face, the first end face and second end face each having a plurality of electrical leads extending therefrom through an aperture, said adapter attachment kit comprising:
a cap structure configured for mated sliding engagement to a first end of the ballast housing, said cap structure including an end wall having a perimeter substantially identical in configuration to the perimeter of the first end face, said end wall having an inside surface and an outside surface, said cap structure further including an attachment rim extending perpendicularly from said perimeter of said end wall, said attachment rim having a top face, a bottom face, left and right side faces, and angled transition faces between said bottom face and said left and right side faces respectively, said top face being adapted for attachment to the mounting plate of the ballast housing, said end wall further including a electrical connector assembly extending therethrough, said electrical connector assembly comprising a plurality of jacks accessible from the inside surface of the end wall wherein said jacks are adapted to be coupled to the electrical leads of the ballast and terminating in a plurality of male electrical connectors extending laterally from the outside surface of said end wall, said attachment rim including an aperture extending therethrough adapted to receive the electrical leads from the second end of the ballast.

8. The adapter attachment kit for converting the conventional ballast to a leadless ballast of claim 7, further comprising a mounting bracket configured for complementary engagement with said ballast housing having said cap structure attached thereto wherein said mounting bracket includes a base adapted for attachment to a fixed structure; said mounting bracket having a width and length approximately equal to the length and width of said ballast housing; said mounting bracket including left and right side walls and a front wall which are contiguous and normal to said base; said front wall including a plurality of female sockets adapted for mated engagement with said male connectors, wherein said female sockets terminate in jacks extending through said front walls and said jacks are adapted to receive a plurality of electrical leads.

9. The adapter attachment kit of claim 8, wherein said bottom face of said ballast housing and said left and right faces respectively include left and right angled faces therebetween, and said left and right side walls of said mounting bracket each have at least one angled panel contiguous thereto configured for coextensive alignment with said left and right angled faces whereby said ballast housing and said cap structure can be inserted into said mounting bracket with said top face adjacent to said fixed structure and maintained in said mounting bracket by said angled panels.

10. The adapter attachment kit of claim 7, wherein the ballast housing includes a base container structure fitted within a cover structure to provide left and right lips depending from the top face along the length of the ballast housing, and said kit further comprises a mounting bracket configured for engagement with said ballast housing having the cap structure attached thereto wherein said mounting bracket includes a base adapted for attachment to a fixed structure; said mounting bracket having a length and a width approximately equal to the length and width of said ballast housing; said mounting bracket including front wall which is contiguous and normal to said base; said front wall including a plurality of female sockets adapted for mated engagement with said male connectors, wherein said female sockets terminate in jacks extending through said front walls and said jacks are adapted to receive a plurality of electrical leads, said mounting bracket including left and right side walls contiguous and normal to said base and having a height somewhat greater than the left and right lips of the ballast housing, said left and right side walls respectively terminating in a downwardly-angled flanges configured to engage with the left and right lips of the ballast housing, whereby said ballast housing can be inserted into said mounting bracket with said top face adjacent to said fixed structure and maintained in said mounting bracket by said downwardly angled flanges.
